(19) United States
(12) Patent Application Publication
(10) Pub. No.: US 2025/0305372 A1
(43) Pub. Date: Oct. 2, 2025

(54) FLUID TRANSFER ASSEMBLY

(71) Applicant: Scout Surface Solutions, LLC, Joshua, TX (US)

(72) Inventors: Thomas George Roesner, Cypress, TX (US); David Lane Evans, Conroe, TX (US); Christopher Mark Koch, Covington, TX (US)

(21) Appl. No.: 18/869,429

(22) PCT Filed: May 26, 2023
(86) PCT No.: PCT/US2023/023650

§ 371 Date: Nov. 26, 2024

Related U.S. Application Data
(60) Provisional application No. 63/346,191, filed on May 26, 2022.

(51) Int. Cl. E21B 17/042; E21B 43/26; F16L 15/00

(52) U.S. Cl. CPC E21B 17/042; F16L 15/006; E21B 43/2607

(57) ABSTRACT

A fluid transfer assembly includes a first wellbore casing positioned above-ground. The first wellbore casing is configured to receive fluid from a fluid supply system and to provide the fluid to a well assembly. The fluid transfer assembly also includes a second wellbore casing positioned above-ground. The second wellbore casing is configured to receive the fluid from the fluid supply system and to provide the fluid to the well assembly. In addition, the fluid transfer assembly includes a connection assembly coupling the first wellbore casing and the second wellbore casing. The first wellbore casing and the second wellbore casing are configured to be disposed within a wellbore to facilitate fluid flow through the wellbore.

### BACKGROUND

The present disclosure relates generally to a fluid transfer assembly.

Various resources (e.g., hydrocarbon gas, oil, etc.) may be extracted from subterranean formations by drilling wells into the subterranean formations. During production, one or more resources may flow from the subterranean formation to a wellhead via the well. The wellhead may include components (e.g., valves, connectors, etc.) configured to control flow of the one or more resources to storage and/or processing assemblies.

For a subterranean formation having low porosity and/or low permeability, and/or when flow of the one or more resources from a subterranean formation decreases, a well stimulation system may be employed to perform a well stimulation operation to fracture the subterranean formation, thereby increasing the flow of the one or more resources from the subterranean formation. The well stimulation system typically includes a well stimulation fluid supply system and a well stimulation tree. The well stimulation fluid supply system includes a fluid source configured to output fracturing fluid (e.g., including water, sand, proppant, acid, chemicals, additives, etc.) and one or more pumps configured to significantly increase the pressure of the fracturing fluid. The well stimulation fluid supply system is configured to output the high-pressure fracturing fluid to the well stimulation tree. The well stimulation tree is coupled to the wellhead and configured to direct the high-pressure fracturing fluid through the wellhead and the well to the subterranean formation.

In certain applications, the well stimulation fluid supply system may be positioned remote from the well stimulation tree. For example, if the well/well stimulation tree is positioned near homes, the well stimulation fluid supply system may be positioned away from the homes to reduce noise at the well/well stimulation tree. Furthermore, the terrain near the well/well stimulation tree may not be suitable for the well stimulation fluid supply system. Accordingly, the well stimulation fluid supply system may be positioned in an area with suitable terrain remote from the well/well stimulation tree. A fluid transfer assembly is used to fluidly couple the well stimulation fluid supply system to the well stimulation tree. The fluid transfer assembly generally includes multiple fluid conduits (e.g., spool irons) coupled to one another to establish a flow path between the well stimulation fluid supply system and the well stimulation tree. Each conduit may be a steel forging about 8 to 10 feet (2.44 to 3.05 meters) long and may be rated for a working pressure of about 15,000 psi and a maximum design pressure (e.g., burst pressure) of about 37,500 psi. Due to the short length of each conduit, a large number of conduits may be used to establish the fluid transfer assembly. In addition, due to the high pressure rating, each conduit may have significant weight and cost. As a result, forming the fluid transfer assembly may be significantly time-consuming and costly.

### BRIEF DESCRIPTION

In certain embodiments, a fluid transfer assembly includes a first wellbore casing positioned above-ground. The first wellbore casing is configured to receive fluid from a fluid supply system and to provide the fluid to a well assembly. The fluid transfer assembly also includes a second wellbore casing positioned above-ground. The second wellbore casing is configured to receive the fluid from the fluid supply system and to provide the fluid to the well assembly. In addition, the fluid transfer assembly includes a connection assembly coupling the first wellbore casing and the second wellbore casing. The first wellbore casing and the second wellbore casing are configured to be disposed within a wellbore to facilitate fluid flow through the wellbore.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a well stimulation system;

FIG. 2 is a perspective view of an embodiment of a fluid transfer assembly that may be employed within the well stimulation system of FIG. 1;

FIG. 3 is a cross-sectional view of an embodiment of a connection assembly and a portion of another embodiment of a connection assembly that may be employed within the fluid transfer assembly of FIG. 2;

FIG. 4 is a cross-sectional view of a portion of a further embodiment of a connection assembly that may be employed within the fluid transfer assembly of FIG. 2;

FIG. 5 is a cross-sectional view of a portion of an embodiment of a connection assembly that may be employed within the fluid transfer assembly of FIG. 2;

FIG. 6 is a cross-sectional view of a portion of a further embodiment of a connection assembly that may be employed within the fluid transfer assembly of FIG. 2;

FIG. 7 is a cross-sectional view of a portion of an embodiment of a connection assembly and a portion of another embodiment of a connection assembly that may be employed within the fluid transfer assembly of FIG. 2;

FIG. 8 is a cross-sectional view of a portion of a further embodiment of a connection assembly that may be employed within the fluid transfer assembly of FIG. 2; and

FIG. 9 is a flow diagram of an embodiment of a method for forming a fluid transfer assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

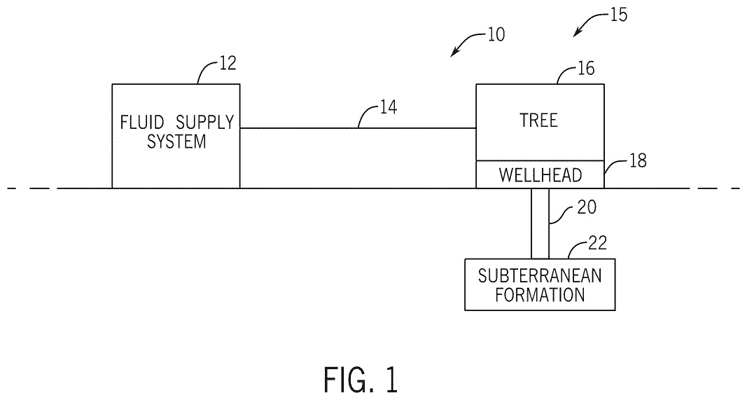

FIG. 1 is a block diagram of an embodiment of a well stimulation system 10. In the illustrated embodiment, the well stimulation system 10 includes a well stimulation fluid supply system 12, a fluid transfer assembly 14, and a well assembly 15, which includes a well stimulation tree 16 and a wellhead 18. The well stimulation fluid supply system 12 is configured to provide high-pressure fracturing fluid to the fluid transfer assembly 14, and the fluid transfer assembly 14, in turn, is configured to provide the high-pressure fracturing fluid to the well assembly 15 (e.g., to the well stimulation tree 16 of the well assembly 15). As illustrated, the well stimulation tree 16 is coupled to the wellhead 18, and the well stimulation tree 16 is configured to direct the high-pressure fracturing fluid through the wellhead 18 and a well 20 to a subterranean formation 22. The high-pressure fracturing fluid may fracture the subterranean formation 22 (e.g., by increasing the size of natural fractures, by forming new fractures, etc.). As a result, the production of resources (e.g., hydrocarbon gas, oil, etc.) from the subterranean formation may be increased.

In the illustrated embodiment, the well stimulation system 10 includes a single well assembly 15. However, in other embodiments, the well stimulation system may include multiple well assemblies (e.g., 2, 3, 4, or more) and a well stimulation manifold configured to direct the high-pressure fracturing fluid from the fluid transfer assembly to the well assemblies. Furthermore, in certain embodiments, the well stimulation system may include multiple well assemblies (e.g., 2, 3, 4, or more), and the fluid transfer assembly may be fluidly coupled to each well assembly individually in a cyclical/repeating pattern (e.g., by moving at least a portion of the fluid transfer assembly).

In certain embodiments, the well stimulation fluid supply system 12 includes a fluid source, fluid pumps, and a fluid conduit assembly. The fluid source is configured to output low-pressure fracturing fluid to the fluid conduit assembly, and the fluid conduit assembly is configured to provide the low-pressure fracturing fluid to the fluid pumps. The fluid pumps are configured to significantly increase the pressure and, in certain embodiments flow rate, of the fracturing fluid and to provide the high-pressure fracturing fluid to the fluid conduit assembly. In addition, the fluid conduit assembly is configured to provide the high-pressure fracturing fluid to the fluid transfer assembly.

In certain embodiments, the fluid transfer assembly is formed from multiple wellbore casings coupled to one another to establish a fluid path between the well stimulation fluid supply system and the well assembly (e.g., the well stimulation tree of the well assembly). For example, in certain embodiments, the fluid transfer assembly includes a first wellbore casing positioned above-ground, in which the first wellbore casing is configured to receive fluid (e.g., high-pressure fracturing fluid, etc.) from a fluid supply system (e.g., the well stimulation fluid supply system, etc.) and to provide the fluid to a well assembly (e.g., the well assembly having the well stimulation tree, etc.). In addition, the fluid transfer assembly includes a second wellbore casing positioned above-ground, in which the second wellbore casing is configured to receive the fluid from the fluid supply system and to provide the fluid to the well assembly. The fluid transfer assembly also includes a connection assembly coupling the first wellbore casing and the second wellbore casing. As discussed in detail below, a variety of types of connectors may be used within the connection assembly. Furthermore, the first wellbore casing and the second wellbore casing are configured to be disposed within a wellbore of a well to facilitate fluid flow through the wellbore. For example, the wellbore casings of the fluid transfer assembly may be the same type of wellbore casings used within the well of the well stimulation system. Because the fluid transfer assembly is formed from wellbore casings, the duration associated with forming the fluid transfer assembly may be substantially reduced (e.g., as compared to a fluid transfer assembly formed from spool irons, in which each spool iron has a significantly greater weight and a significantly shorter length than a respective wellbore casing). In addition, the cost of the fluid transfer assembly may be significantly reduced (e.g., as compared to a fluid transfer assembly formed from significantly more expensive spool irons).

While the fluid transfer assembly is disclosed herein with regard to a well stimulation system, the fluid transfer assembly, as described herein, may also be employed within any other suitable system configured to provide fluid to a well. For example, in certain embodiments, the fluid transfer assembly may be employed within a well intervention system. The well intervention system may provide intervention fluid (e.g., including water, acid, sand, proppant, etc.) to a well to further fracture the subterranean formation, thereby increasing production of resources from the well.

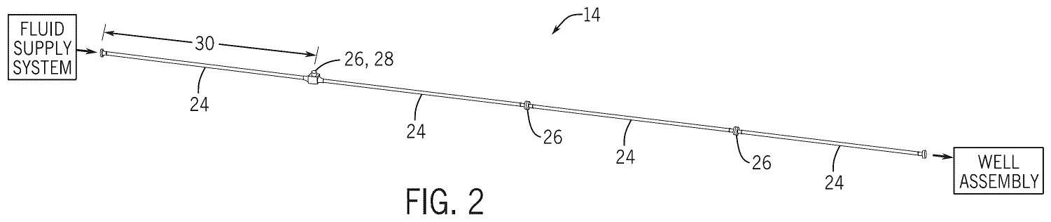

FIG. 2 is a perspective view of an embodiment of a fluid transfer assembly 14 that may be employed within the well stimulation system of FIG. 1. As previously discussed, the fluid transfer assembly 14 is configured to receive fluid (e.g., high-pressure fracturing fluid) from a fluid supply system (e.g., the well stimulation fluid supply system disclosed above, etc.), and the fluid transfer assembly 14 is configured to provide the fluid to a well assembly (e.g., the well assembly disclosed above, etc.). In the illustrated embodiment, the fluid transfer assembly 14 is formed from multiple wellbore casings 24 coupled to one another by connection assemblies 26. Each connection assembly 26 is configured to fixedly couple a pair of adjacent wellbore casings 24 and to provide a seal configured to substantially block flow of fluid out of the interface between the adjacent wellbore casings. As discussed in detail below, a variety of types of connection assemblies may be used to couple the wellbore casings to one another. Furthermore, in certain embodiments, at least one connection assembly 26 may include a junction 28 configured to facilitate coupling another component (e.g., conduit, valve, etc.) to the fluid transfer assembly. For example, a conduit may be coupled to the junction to direct the fluid to a second location, to receive fluid from a second source, etc. By way of further example, a plug valve may be coupled to a top of the junction to enable air to exit the fluid transfer assembly, while blocking liquid flow from the fluid transfer assembly. Additionally or alternatively, a pressure relief valve (e.g., spring-actuated valve, nitrogen-actuated valve, rupture disc valve, etc.) may be coupled to the junction 28 to enable the fluid to exit the fluid transfer assembly (e.g., via a conduit) in response to the fluid pressure within the fluid transfer assembly exceeding a threshold value, thereby limiting the fluid pressure within the wellbore casings to a fluid pressure below (e.g., significantly below) a maximum design pressure (e.g., burst pressure). While the fluid transfer assembly 14 includes four wellbore casings 24 in the illustrated embodiment, in other embodiments, the fluid transfer assembly may include more or fewer wellbore casings and a corresponding number of connection assemblies.

In the illustrated embodiment, each wellbore casing 24 is positioned above-ground. As used herein, “above-ground” refers to any position at or above a surface of the ground, including on the ground. The wellbore casings 24 may be supported above the ground by any suitable type(s) of support(s). For example, in certain embodiments, one or more stands may support each wellbore casing above the ground. Furthermore, in certain embodiments, at least one wellbore casing and/or a portion of at least one wellbore casing may directly contact the ground, such that the wellbore casing(s)/portion(s) of the wellbore casing(s) are supported directly by the ground. While each wellbore casing 24 is positioned above-ground in the illustrated embodiment, in other embodiments, at least one wellbore casing and/or portion(s) of at least one wellbore casing may be positioned below-ground. For example, at least a portion of the fluid transfer assembly (e.g., an entirety of the fluid transfer assembly) may be subterranean. Furthermore, in certain embodiments, each wellbore casing of the fluid transfer assembly is positioned outside of a wellbore of the well.

Each wellbore casing 24 is configured (e.g., designed, etc.) to be disposed within a wellbore of a well to facilitate fluid flow through the wellbore. For example, the wellbore casings 24 of the fluid transfer assembly 14 may be the same type of wellbore casings used within the well of the well stimulation system disclosed herein. However, in other embodiments, the wellbore casings of the fluid transfer assembly may be configured to be used in the wellbore of another well. Furthermore, in certain embodiments, the fluid transfer assembly may be formed from multiple types of wellbore casings configured to be used in different wells.

In certain embodiments, a maximum design pressure (e.g., burst pressure) of each wellbore casing is greater than 15,000 psi. For example, in certain embodiments, the maximum design pressure (e.g., burst pressure) of at least one wellbore casing is less than 25,000 psi, less than 22,000 psi, less than 20,000 psi, less than 18,000 psi, or less than 17,000 psi. Accordingly, the weight of each wellbore casing may be significantly less than the weight of a respective spool iron, which is used in certain applications to transfer fluid from a fluid supply system to a well assembly. As a result, lighter equipment having a lower acquisition/rental cost may be used to lift and position each wellbore casing (e.g., as compared to heavier equipment having a higher acquisition/rental cost used to lift and position each spool iron). Furthermore, the cost of each wellbore casing may be significantly less than the cost of a respective spool iron.

In addition, each wellbore casing 24 may have a length 30 of at least 15 feet (4.57 m), at least 20 feet (6.10 m), at least 25 feet (7.62 m), at least 30 feet (9.14 m), at least 35 feet (10.67 m), at least 40 feet (12.19 m), at least 45 feet (13.72 m), or at least 50 feet (15.24 m). For example, at least one wellbore casing 24 may have a length of 42 feet (12.80 m). Due to the length of each wellbore casing 24, fewer wellbore casings may be used to extend between the fluid supply system and the well assembly (e.g., as compared to spool irons each having a length of 8 to 10 feet (2.44 to 3.05 m)). Accordingly, the duration and costs associated with forming the fluid transfer assembly may be substantially reduced.

In certain embodiments, the fluid transfer assembly 14 extends directly between the fluid supply system (e.g., the well stimulation fluid supply system, etc.) and the well assembly (e.g., the well assembly having the well stimulation tree, etc.) along a substantially straight path. By way of example, flexible conduit(s) may be coupled to at least one end of the fluid transfer assembly. For example, a flexible conduit may couple one end of the fluid transfer assembly to the fluid supply system, and/or a flexible conduit may couple the other end of the fluid transfer assembly to the well assembly. The flexible conduit(s) enable the fluid transfer assembly to extend directly between the fluid supply system and the well assembly along a substantially straight path (e.g., as compared to a fluid transfer assembly formed from spool irons and 90-degree junction(s)). Extending between the fluid supply system and the well assembly along a substantially straight path may reduce the number of wellbore casings within the fluid transfer assembly, thereby reducing the cost and duration associated with forming the fluid transfer assembly. While using flexible conduit(s) to establish the substantially straight path is disclosed above, in certain embodiments, other suitable connector(s) (e.g., angled connector(s), etc.) may be coupled to at least one end of the fluid transfer assembly to enable the fluid transfer assembly to extend along a substantially straight path between the fluid supply system and the well assembly.

The wellbore casings 24 are significantly more flexible than spool irons, which are used in certain applications to transfer fluid from a fluid supply system to a well assembly. Accordingly, the fluid transfer assembly 14 may follow contours within the terrain (e.g., as compared to a fluid transfer assembly formed with substantially rigid spool irons). As a result, the cost and duration associated with forming the fluid transfer assembly may be reduced (e.g., as compared to a fluid transfer assembly formed from substantially rigid spool irons, in which stands supporting the spool irons are disposed on a prepared surface, such as a road, and adjusted to account for variations in the terrain). Furthermore, the wellbore casings 24 may be significantly easier to bend than spool irons. Accordingly, certain wellbore casings 24 of the fluid transfer assembly 14 may be bent to establish an efficient path between the fluid supply system and the well assembly, thereby reducing the length of the fluid transfer assembly 14 (e.g., as compared to a fluid transfer assembly formed with substantially straight and substantially rigid spool irons and substantially rigid angled connectors). In addition, one or more wellbore casings may be bent to establish a gentle (e.g., large radius of curvature) curve within the fluid transfer assembly, thereby reducing losses associated with a sharper (e.g., smaller radius of curvature) curve of an angled connector (e.g., used to connect substantially straight and substantially rigid spool irons). As a result, less energy may be used to move the fluid through the fluid transfer assembly, thereby reducing energy consumption, operating costs, and carbon emissions. Furthermore, in certain embodiments, one or more connection assemblies may facilitate formation of the gentle bend of the fluid transfer assembly. For example, at least one connection assembly may establish a curved interface between respective wellbore casings within the bend (e.g., the radius of curvature of the curved interface formed by each connection assembly may be substantially equal to the radius of curvature of the respective wellbore casings), thereby establishing a smooth transition between wellbore casings. In addition, in certain embodiments, at least one connection assembly may establish a curved interface between respective straight wellbore casings and/or between bent wellbore casing(s) and straight wellbore casing(s). For example, in certain embodiments, the fluid transfer assembly may include straight wellbore casings, and the connection assemblies may establish one or more curved interfaces between respective straight wellbore casings to control the path of the fluid transfer assembly. Additionally or alternatively, the fluid transfer assembly may include a first portion formed with bent wellbore casings, and a second portion formed with straight wellbore casings and one or more connection assemblies configured to establish curved interface(s) between the straight wellbore casings. While the fluid transfer assembly 14 is formed from wellbore casings 24 in the illustrated embodiment, in other embodiments, the fluid transfer assembly may be formed from a combination of wellbore casings and other suitable conduit(s) (e.g., spool iron(s), flexible conduit(s), etc.).

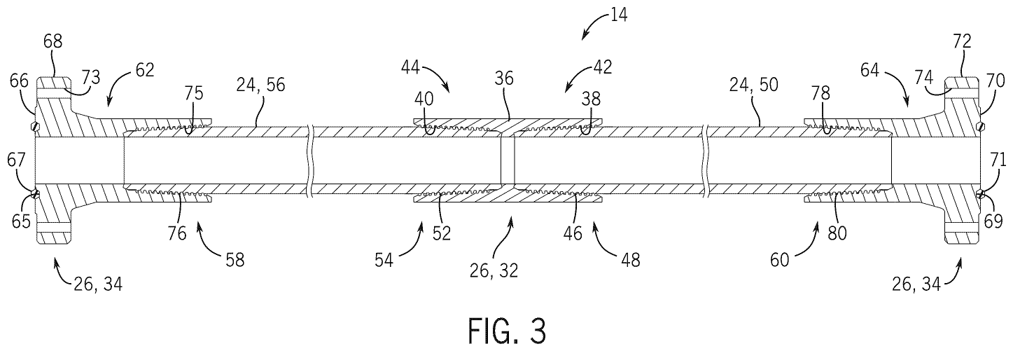

FIG. 3 is a cross-sectional view of an embodiment of a connection assembly 32 and a portion of another embodiment of a connection assembly 34 that may be employed within the fluid transfer assembly 14 of FIG. 2. For example, first connection assembly/assemblies 32, second connection assembly/assemblies 34, or any suitable combination of first and second connection assemblies may be used as at least a portion of the connection assemblies 26 within the fluid transfer assembly 14 (e.g., the fluid transfer assembly may include any suitable number of first connection assemblies and/or any suitable number of second connection assemblies). In the illustrated embodiment, the first connection assembly 32 includes a collar 36 having first interior threads 38 and second interior threads 40. The first interior threads 38 are positioned at a first longitudinal end 42 of the collar 36, and the second interior threads 40 are positioned at a second longitudinal end 44 of the collar 36. The first interior threads 38 are configured to engage first exterior threads 46 at a first longitudinal end 48 of a first wellbore casing 50. In addition, the second interior threads 40 are configured to engage second exterior threads 52 at a second longitudinal end 54 of a second wellbore casing 56. Engagement of the first interior threads 38 of the collar 36 with the first exterior threads 46 of the first wellbore casing 50 and engagement of the second interior threads 40 of the collar 36 with the second exterior threads 52 of the second wellbore casing 56 fixedly couples the wellbore casings to one another and establishes a seal between the wellbore casings that substantially blocks fluid flow out of the interface between the wellbore casings.

In certain embodiments, the collar 36 is the same type of collar used to couple wellbore casings to one another within a wellbore of a well. However, in other embodiments, different types of collars may be used for the wellbore casings of the fluid transfer assembly and the wellbore casings within a wellbore of a well. In certain embodiments, each pair of adjacent wellbore casings is coupled via a respective collar. However, in other embodiments, a collar may be used to couple a first pair of adjacent wellbore casings to one another, and another suitable type of connection assembly may be used to couple a second pair of adjacent wellbore casings to one another. Furthermore, in certain embodiments, at least one pair of wellbore casings may be coupled to one another by a collar before the pair of wellbore casings is transported to the site of the well stimulation system. Additionally or alternatively, at least one pair of wellbore casings may be coupled to one another by a collar at the site of the well stimulation system.

In the illustrated embodiment, a second connection assembly 34 is positioned at a first longitudinal end 58 of the second wellbore casing 56, and a second connection assembly 34 is positioned at a second longitudinal end 60 of the first wellbore casing 50. Each second connection assembly 34 includes a first flange assembly 62 and a second flange assembly 64. The first flange assembly 62 includes a first hub 66 and a first flange 68, and the second flange assembly 64 includes a second hub 70 and a second flange 72. In the illustrated embodiment, the illustrated first flange assembly 62 is configured to couple to a second flange assembly at a second longitudinal end of another wellbore casing. The first flange 68 of the illustrated first flange assembly 62 is configured to couple to a second flange of the second flange assembly to establish a seal between the first hub 66 of the illustrated first flange assembly 62 and a second hub of the second flange assembly. In addition, the first flange assembly 62 may be configured to couple to the fluid supply system, to the well assembly (e.g., to the tree of the well assembly), to another suitable conduit, or a combination thereof. Furthermore, the illustrated second flange assembly 64 is configured to couple to a first flange assembly at a first longitudinal end of another wellbore casing. The second flange 72 of the illustrated second flange assembly 64 is configured to couple to a first flange of the first flange assembly to establish a seal between the second hub 70 of the illustrated second flange assembly 64 and a first hub of the first flange assembly. In addition, the second flange assembly 64 may be configured to couple to the fluid supply system, to the well assembly (e.g., to the tree of the well assembly), to another suitable conduit, or a combination thereof.

In the illustrated embodiment, the first hub 66 includes an annular recess 65 configured to receive a seal 67 (e.g., American Petroleum Institute (API) 6A ring gasket, metal seal, elastomeric seal, etc.), and the second hub 70 includes an annular recess 69 configured to receive a seal 71 (e.g., API 6A ring gasket, metal seal, elastomeric seal, etc.). Each seal is configured to provide the seal between the first and second hubs of a respective second connection assembly 34. For example, the seal may engage the first annular recess 65 in the first hub 66 and the second annular recess 69 in the second hub 70, and the seal may be compressed between the hubs via the coupling of the respective flanges. Furthermore, in the illustrated embodiment, the first flange 68 includes respective openings 73 (e.g., substantially evenly distributed along a circumferential axis of the first flange), and the second flange 72 includes respective openings 74 (e.g., substantially evenly distributed along a circumferential axis of the second flange). Fasteners may extend through the openings in the first flange and the openings in the second flange to couple the flanges to one another.

In the illustrated embodiment, the first hub 66 has first interior threads 75 configured to engage first exterior threads 76 at the first longitudinal end 58 of the respective wellbore casing 24. In addition, the second hub 70 has second interior threads 78 configured to engage second exterior threads 80 of the respective wellbore casing 24. Engagement of the first interior threads 75 of the first hub 66 with the first exterior threads 76 of the respective wellbore casing 24 couples the first flange assembly 62 to the respective wellbore casing 24, and engagement of the second interior threads 78 of the second hub 70 with the second exterior threads 80 of the respective wellbore casing 24 couples the second flange assembly 64 to the respective wellbore casing 24. While each hub is coupled to the respective wellbore casing with a threaded connection in the illustrated embodiment, in other embodiments, at least one hub may be coupled to the respective wellbore casing by a welded connection, as discussed in detail below, or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types).

In the illustrated embodiment, the first flange assembly 62 is formed from a single piece of material, and the second flange assembly 64 is formed from a single piece of material. Accordingly, each flange assembly does not include any welded connections, adhesive connections, or fasteners. For example, each flange assembly may be formed by a casting process, a forging process, a machining process, an additive manufacturing process, other suitable manufacturing process(es), or a combination thereof. While each flange assembly is formed from a single piece of material in the illustrated embodiment, in other embodiments, at least one flange assembly may be formed from multiple pieces of material coupled to one another. For example, in certain embodiments, the flange and the hub may be separate components coupled to one another to form the respective flange assembly.

In certain embodiments, each pair of adjacent wellbore casings of the fluid transfer assembly is coupled to one another via a respective pair of flange assemblies. However, in other embodiments, a pair of flange assemblies may be used to couple a first pair of adjacent wellbore casings to one another, and another suitable type of connection assembly may be used to couple a second pair of adjacent wellbore casings to one another. Furthermore, in certain embodiments, at least one pair of wellbore casings may be coupled to one another by a pair of flange assemblies before the pair of wellbore casings is transported to the site of the well stimulation system. Additionally or alternatively, at least one pair of wellbore casings may be coupled to one another by a pair of flange assemblies at the site of the well stimulation system.

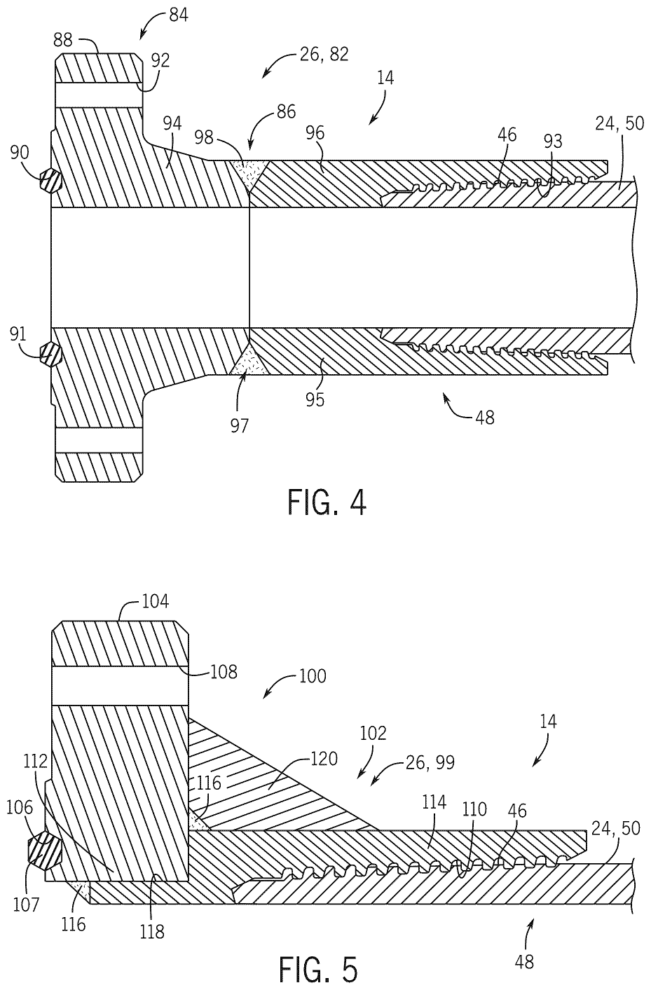

FIG. 4 is a cross-sectional view of a portion of a further embodiment of a connection assembly 82 that may be employed within the fluid transfer assembly 14 of FIG. 2. In the illustrated embodiment, the connection assembly 82 includes a first flange assembly 84 and a second flange assembly. As illustrated, the first flange assembly 84 is positioned at the first longitudinal end 48 of the first wellbore conduit 50. The first flange assembly 84 includes a first hub 86 and a first flange 88, and the second flange assembly includes a second hub and a second flange. The first and second flanges are configured to couple to one another to establish a seal between the first and second hubs. In the illustrated embodiment, the first flange assembly 84 is configured to couple to the second flange assembly, which is positioned at a second longitudinal end of a second wellbore casing. In addition, the first flange assembly 84 and/or the second flange assembly may also be configured to couple to the fluid supply system, to the well assembly (e.g., to the tree of the well assembly), to another suitable conduit, or a combination thereof.

In the illustrated embodiment, each hub includes an annular recess 90 configured to receive a seal 91 (e.g., API 6A ring gasket, metal seal, elastomeric seal, etc.), which is configured to provide the seal between the first and second hubs. For example, the seal may engage the first annular recess 90 in the first hub 86 and the second annular recess in the second hub, and the seal may be compressed between the hubs via the coupling of the flanges. Furthermore, in the illustrated embodiment, each flange includes respective openings 92 (e.g., substantially evenly distributed along a circumferential axis of the flange). Fasteners may extend through the openings 92 in the first flange and the openings in the second flange to couple the flanges to one another.

In the illustrated embodiment, the first hub 86 has first interior threads 93 configured to engage the first exterior threads 46 at the first longitudinal end 48 of the first wellbore casing 50. In addition, the second hub has second interior threads configured to engage the second exterior threads at the second longitudinal end of the second wellbore casing. Engagement of the first interior threads 93 of the first hub 86 with the first exterior threads 46 of the first wellbore casing 50 couples the first flange assembly 84 to the first wellbore casing 50, and engagement of the second interior threads of the second hub with the second exterior threads of the second wellbore casing couples the second flange assembly to the second wellbore casing. While each hub is coupled to the respective wellbore casing with a threaded connection in the embodiment disclosed herein, in other embodiments, at least one hub may be coupled to the respective wellbore casing by a welded connection, as discussed in detail below, or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types).

In the illustrated embodiment, the first hub 86 includes a first portion 94 and a second portion 96. The first portion 94 of the first hub 86 is integrally formed with the first flange 88, and the second portion 96 of the first hub 86 includes the interior threads 93. The first portion 94 and the second portion 96 of the first hub 86 may be non-rotatably and non-movably coupled to one another by any suitable type(s) of connection(s), such as welded connection(s), adhesive connection(s), fastener connection(s), pinned connection(s), other suitable type(s) of connection(s), or a combination thereof. For example, in the illustrated embodiment, the first portion 94 and the second portion 96 of the first hub 86 form a v-shaped notch 97 at the interface between the first and second portions, thereby facilitating coupling the first and second portions to one another by a welded connection 98 along the v-shaped notch. While a v-shaped notch is formed at the interface between the first and second portions in the illustrated embodiment, in other embodiments, the v-shaped notch may be omitted. In the illustrated embodiment, the second portion 96 of the first hub 86 has a spacer section 95 disposed between the interior threads 93 and the first portion 94. The spacer section 95 may enable a new set of interior threads to be formed (e.g., machined) into the material of the second portion 96 (e.g., in response to wear of the original interior threads). While the second portion 96 of the first hub 86 includes the spacer section 95 in the illustrated embodiment, in other embodiments, the spacer section may be omitted. Furthermore, in certain embodiments, the second hub includes a first portion and a second portion. The first portion of the second hub is integrally formed with the second flange, and the second portion of the second hub includes the interior threads. The first portion and the second portion of the second hub may be non-rotatably and non-movably coupled to one another by any suitable type(s) of connection(s), such as welded connection(s), adhesive connection(s), fastener connection(s), pinned connection(s), other suitable type(s) of connection(s), or a combination thereof. In addition, in certain embodiments, the second portion of the second hub has a spacer section disposed between the interior threads and the first portion. The spacer section may enable a new set of interior threads to be formed (e.g., machined) into the material of the second portion (e.g., in response to wear of the original interior threads). While the second portion of the second hub includes the spacer section in the embodiment disclosed herein, in other embodiments, the spacer section may be omitted.

The first portion of each hub may be integrally formed with the respective flange by a casting process, a forging process, a machining process, an additive manufacturing process, other suitable manufacturing process(es), or a combination thereof. For example, the first portion of at least one hub (e.g., the first portion of each hub) may be formed from a single piece of material (e.g., via a casting process, a forging process, a machining process, an additive manufacturing process, other suitable manufacturing process(es), or a combination thereof). Additionally or alternatively, the first portion of at least one hub (e.g., the first portion of each hub) and the respective integrally formed flange may be a commercially available (e.g., off-the-shelf) component. While the first portion of each hub is integrally formed with the respective flange in the embodiment disclosed herein, in certain embodiments, the first portion of at least one hub may be formed separately from the respective flange and coupled to the flange by any suitable type(s) of connection(s). Furthermore, in certain embodiments, the second portion of at least one hub may be half of the collar disclosed above with reference to FIG. 3. For example, one half of the collar may be used as the second portion of the first hub, and the other half of the collar may be used as the second portion of the second hub. Because the hub is formed from two portions (e.g., one portion being commercially available and including an integrally formed flange, and/or the other portion being half of a collar), the cost of the flange assembly may be reduced (e.g., as compared to a one-piece integrally formed flange assembly). In addition, if the interior threads of the flange assembly become worn, the second portion of the hub may be removed and replaced, thereby enabling the first portion of the hub and the flange to be reused, thereby reducing costs. While the first portion of each hub extends beyond the respective flange along a direction toward the second portion of the hub in the embodiment disclosed herein, in other embodiments, the first portion of at least one hub may not extend beyond the respective flange along the direction toward the second portion of the hub.

FIG. 5 is a cross-sectional view of a portion of an embodiment of a connection assembly 99 that may be employed within the fluid transfer assembly 14 of FIG. 2. In the illustrated embodiment, the connection assembly 99 includes a first flange assembly 100 and a second flange assembly. As illustrated, the first flange assembly 100 is positioned at the first longitudinal end 48 of the first wellbore conduit 50. The first flange assembly 100 includes a first hub 102 and a first flange 104, and the second flange assembly includes a second hub and a second flange. The first and second flanges are configured to couple to one another to establish a seal between the first and second hubs. In the illustrated embodiment, the first flange assembly 100 is configured to couple to the second flange assembly, which is positioned at a second longitudinal end of a second wellbore casing. In addition, the first flange assembly 100 and/or the second flange assembly may also be configured to couple to the fluid supply system, to the well assembly (e.g., to the tree of the well assembly), to another suitable conduit, or a combination thereof.

In the illustrated embodiment, each hub includes an annular recess 106 configured to receive a seal 107 (e.g., API 6A ring gasket, metal seal, elastomeric seal, etc.), which is configured to provide the seal between the first and second hubs. For example, the seal may engage the first annular recess 106 in the first hub 102 and the second annular recess in the second hub, and the seal may be compressed between the hubs via the coupling of the flanges. Furthermore, in the illustrated embodiment, each flange includes respective openings 108 (e.g., substantially evenly distributed along a circumferential axis of the flange). Fasteners may extend through the openings 108 in the first flange and the openings in the second flange to couple the flanges to one another.

In the illustrated embodiment, the first hub 102 has first interior threads 110 configured to engage the first exterior threads 46 at the first longitudinal end 48 of the first wellbore casing 50. In addition, the second hub has second interior threads configured to engage the second exterior threads of the second wellbore casing. Engagement of the first interior threads 110 of the first hub 102 with the first exterior threads 46 of the first wellbore casing 50 couples the first flange assembly 100 to the first wellbore casing 50, and engagement of the second interior threads of the second hub with the second exterior threads of the second wellbore casing couples the second flange assembly to the second wellbore casing. While each hub is coupled to the respective wellbore casing with a threaded connection in the embodiment disclosed herein, in other embodiments, at least one hub may be coupled to the respective wellbore casing by a welded connection, as discussed in detail below, or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types).

In the illustrated embodiment, the first hub 102 includes a first portion 112 and a second portion 114. The first portion 112 of the first hub 102 is integrally formed with the first flange 104, and the second portion 114 of the first hub 102 includes the first interior threads 110. In the illustrated embodiment, the first portion 112 and the second portion 114 of the first hub 102 are non-rotatably and non-movably coupled to one another by two welded connections 116. However, in other embodiments, the first and second portions of the first hub 102 may be non-rotatably and non-movably coupled to one another by more or fewer welded connections (e.g., 1, 3, 4, 5, 6, or more). Furthermore, in certain embodiments, the first and second portions of the first hub 102 may be non-rotatably and non-movably coupled to one another by any suitable type(s) of connection(s) (e.g., alone or in combination with the welded connection(s)), such as adhesive connection(s), fastener connection(s), pinned connection(s), other suitable type(s) of connection(s), or a combination thereof. In the illustrated embodiment, the welded connections 116 block flow of the fluid through the interface between the first portion 112 and the second portion 114 of the first hub 102. In certain embodiments, seal(s) (e.g., o-ring(s), etc.) may be disposed between the first portion and the second portion to block fluid flow through the interface between the first and second portions.

Furthermore, in the illustrated embodiment, the first portion 112 of the first hub 102 is disposed within a recess 118 of the second portion 114 of the first hub 102. However, in other embodiments, the first and second portions of the first hub may be engaged with one another via a non-overlapping connection, or the second portion of the first hub may be disposed within a recess of the first portion of the first hub. In addition, in the illustrated embodiment, the first flange assembly 100 includes a first gusset 120 (e.g., an annular gusset, an arcuate gusset, a gusset having multiple arcuate portions, etc.) extending between the first flange 104 and/or the first portion 112 of the first hub 102 and the second portion 114 of the first hub 102. The first gusset 120 is coupled to the first flange 104 and/or the first portion 112 of the first hub 102 and the second portion 114 of the first hub 102 (e.g., via welded connection(s), adhesive connection(s), fastener connection(s), pinned connection(s), etc.) and configured to increase the strength of the connection between the first flange 104/first portion 112 of the first hub 102 and the second portion 114 of the first hub 102. While the first flange assembly includes the first gusset in the illustrated embodiment, in other embodiments, the first gusset may be omitted.

In certain embodiments, the second hub includes a first portion and a second portion. The first portion of the second hub is integrally formed with the second flange, and the second portion of the second hub includes the second interior threads. In addition, in certain embodiments, the first portion and the second portion of the second hub are non-rotatably and non-movably coupled to one another by two welded connections. However, in other embodiments, the first and second portions of the second hub may be non-rotatably and non-movably coupled to one another by more or fewer welded connections (e.g., 1, 3, 4, 5, 6, or more). Furthermore, in certain embodiments, the first and second portions of the second hub may be non-rotatably and non-movably coupled to one another by any suitable type(s) of connection(s) (e.g., alone or in combination with the welded connection(s)), such as adhesive connection(s), fastener connection(s), pinned connection(s), other suitable type(s) of connection(s), or a combination thereof. In certain embodiments, the welded connections block flow of the fluid through the interface between the first portion and the second portion of the second hub. Furthermore, in certain embodiments, seal(s) (e.g., o-ring(s), etc.) may be disposed between the first portion and the second portion to block fluid flow through the interface between the first and second portions.

Furthermore, in certain embodiments, the first portion of the second hub is disposed within a recess of the second portion of the second hub. However, in other embodiments, the first and second portions of the second hub may be engaged with one another via a non-overlapping connection, or the second portion of the second hub may be disposed within a recess of the first portion of the second hub. In addition, in certain embodiments, the second flange assembly includes a second gusset (e.g., an annular gusset, an arcuate gusset, a gusset having multiple arcuate portions, etc.) extending between the second flange and/or the first portion of the second hub and the second portion of the second hub. The second gusset is coupled to the second flange and/or the first portion of the second hub and the second portion of the second hub (e.g., via welded connection(s), adhesive connection(s), fastener connection(s), pinned connection(s), etc.) and configured to increase the strength of the connection between the second flange/first portion of the second hub and the second portion of the second hub. While the second flange assembly includes the second gusset in the embodiment disclosed herein, in other embodiments, the second gusset may be omitted.

The first portion of each hub may be integrally formed with the respective flange by a casting process, a forging process, a machining process, an additive manufacturing process, other suitable manufacturing process(es), or a combination thereof. For example, the first portion of at least one hub (e.g., the first portion of each hub) and the respective flange may be formed from a single piece of material (e.g., via a casting process, a forging process, a machining process, an additive manufacturing process, other suitable manufacturing process(es), or a combination thereof). Because the first portion of the hub/respective flange is smaller than the flange assembly disclosed above with reference to FIG. 3, the cost of forming the illustrated flange assembly may be reduced, as compared to forming the flange assembly disclosed above with reference to FIG. 3 (e.g., in which the flange assembly is formed from a single piece of material). Furthermore, in certain embodiments, the first portion of the hub/respective flange may be a commercially available (e.g., off-the-shelf) component (e.g., of any suitable dimensions), and the second portion of the hub may be particularly formed (e.g., machined) to interface with the first portion of the hub and the wellbore conduit. While the first portion of each hub is integrally formed with the respective flange in the embodiment disclosed herein, in certain embodiments, the first portion of at least one hub may be formed separately from the respective flange and coupled to the flange by any suitable type(s) of connection(s). Furthermore, in certain embodiments, the second portion of at least one hub may be half of the collar disclosed above with reference to FIG. 3. For example, one half of the collar may be used as the second portion of the first hub, and the other half of the collar may be used as the second portion of the second hub.

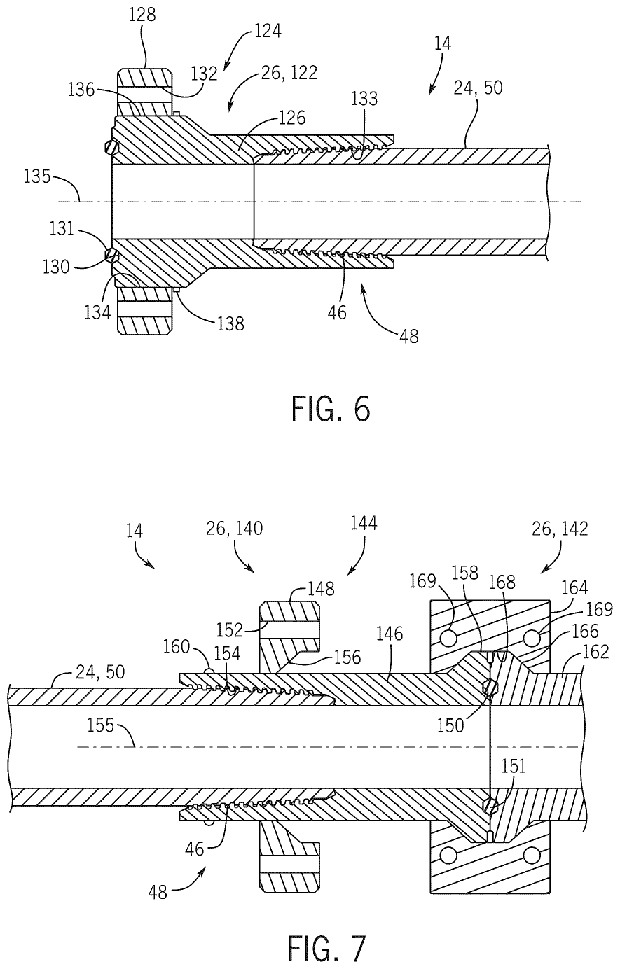

FIG. 6 is a cross-sectional view of a portion of a further embodiment of a connection assembly 122 that may be employed within the fluid transfer assembly 14 of FIG. 2. In the illustrated embodiment, the connection assembly 122 includes a first flange assembly 124 and a second flange assembly. As illustrated, the first flange assembly 124 is positioned at the first longitudinal end 48 of the first wellbore conduit 50. The first flange assembly 124 includes a first hub 126 and a first flange 128, and the second flange assembly includes a second hub and a second flange. The first and second flanges are configured to couple to one another to establish a seal between the first and second hubs. In the illustrated embodiment, the first flange assembly 124 is configured to couple to the second flange assembly, which is positioned at a second longitudinal end of a second wellbore casing. In addition, the first flange assembly 124 and/or the second flange assembly may also be configured to couple to the fluid supply system, to the well assembly (e.g., to the tree of the well assembly), to another suitable conduit, or a combination thereof.

In the illustrated embodiment, each hub includes an annular recess 130 configured to receive a seal 131 (e.g., API 6A ring gasket, metal seal, elastomeric seal, etc.), which is configured to provide the seal between the first and second hubs. For example, the seal may engage the first annular recess 130 in the first hub 126 and the second annular recess in the second hub, and the seal may be compressed between the hubs via the coupling of the flanges. Furthermore, in the illustrated embodiment, each flange includes respective openings 132 (e.g., substantially evenly distributed along a circumferential axis of the flange). Fasteners may extend through the openings 132 in the first flange and the openings in the second flange to couple the flanges to one another.

In the illustrated embodiment, the first hub 126 has first interior threads 133 configured to engage the first exterior threads 46 at the first longitudinal end 48 of the first wellbore casing 50. In addition, the second hub has second interior threads configured to engage the second exterior threads of the second wellbore casing. Engagement of the first interior threads 133 of the first hub 126 with the first exterior threads 46 of the first wellbore casing 50 couples the first flange assembly 124 to the first wellbore casing 50, and engagement of the second interior threads of the second hub with the second exterior threads of the second wellbore casing couples the second flange assembly to the second wellbore casing. While each hub is coupled to the respective wellbore casing with a threaded connection in the embodiment disclosed herein, in other embodiments, at least one hub may be coupled to the respective wellbore casing by a welded connection, as discussed in detail below, or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types). In the embodiment disclosed herein, each hub is formed from a single piece of material (e.g., by a casting process, a forging process, a machining process, an additive manufacturing process, other suitable manufacturing process(es), or a combination thereof). However, in other embodiments, at least one hub may include multiple portions (e.g., as disclosed above) coupled to one another (e.g., a first portion configured to interface with the respective flange and a second portion having the respective interior threads).

In the illustrated embodiment, the first flange 128 has interior threads 134, and the first hub 126 has exterior threads 136. The interior threads 134 of the first flange 128 engage the exterior threads 136 of the first hub 126, thereby coupling the first flange 128 to the first hub 126. The threaded connection enables the first flange 128 to rotate about a longitudinal axis 135 of the first flange assembly 124. As a result, the first flange 128 may be oriented at a suitable angle relative to the second flange, thereby facilitating circumferential alignment of the openings 132 of the first flange with the openings of the second flange. While the first flange 128 has interior threads 134 and the first hub 126 has exterior threads 136 in the illustrated embodiment, in other embodiments, the threads may be omitted, thereby enabling the first flange to rotate about the longitudinal axis and to translate with respect to the longitudinal axis. In the illustrated embodiment, the first hub 126 includes a stop 138 configured to block longitudinal movement of the first flange 128 in a direction toward the first wellbore conduit 50. In the illustrated embodiment, the stop 138 is integrally formed with the first hub 126. However, in other embodiments, the stop may be removable (e.g., the stop may be formed by a ring engaged with a slot in the first hub). Furthermore, in certain embodiments, the stop may be omitted. Prior to coupling the first flange 128 to the second flange, the first flange may be adjusted such that the first flange does not extend beyond the longitudinal end of the first hub 126 in a direction toward the second hub, thereby facilitating engagement between the first and second hubs.

In certain embodiments, the second flange has interior threads, and the second hub has exterior threads. The interior threads of the second flange engage the exterior threads of the second hub, thereby coupling the second flange to the second hub. The threaded connection enables the second flange to rotate about a longitudinal axis of the second flange assembly. As a result, the second flange may be oriented at a suitable angle relative to the first flange, thereby facilitating circumferential alignment of the openings of the second flange with the openings of the first flange. While a second flange having interior threads and a second hub having exterior threads is disclosed above, in certain embodiments, the threads may be omitted, thereby enabling the second flange to rotate about the longitudinal axis and to translate with respect to the longitudinal axis. In certain embodiments, the second hub includes a stop configured to block longitudinal movement of the second flange in a direction toward the second wellbore conduit. In such embodiments, the stop may be integrally formed with the second hub, or the stop may be removable (e.g., the stop may be formed by a ring engaged with a slot in the second hub). Furthermore, in certain embodiments, the stop may be omitted. Prior to coupling the second flange to the first flange, the second flange may be adjusted such that the second flange does not extend beyond the longitudinal end of the second hub in a direction toward the first hub, thereby facilitating engagement between the first and second hubs.

FIG. 7 is a cross-sectional view of a portion of an embodiment of a connection assembly 140 and another embodiment of a connection assembly 142 that may be employed within the fluid transfer assembly 14 of FIG. 2. The first connection assembly 140 and the second connection assembly 142 are independent and not usable together. In the illustrated embodiment, the first connection assembly 140 includes a first flange assembly 144 and a second flange assembly. As illustrated, the first flange assembly 144 is positioned at the first longitudinal end 48 of the first wellbore conduit 50. The first flange assembly 144 includes a first hub 146 and a first flange 148, and the second flange assembly includes a second hub and a second flange. The first and second flanges are configured to couple to one another to establish a seal between the first and second hubs. In the illustrated embodiment, the first flange assembly 144 is configured to couple to the second flange assembly, which is positioned at a second longitudinal end of a second wellbore casing. In addition, the first flange assembly 144 and/or the second flange assembly may also be configured to couple to the fluid supply system, to the well assembly (e.g., to the tree of the well assembly), to another suitable conduit, or a combination thereof.

In the illustrated embodiment, each hub includes an annular recess 150 configured to receive a seal 151 (e.g., API 6A ring gasket, metal seal, elastomeric seal, etc.), which is configured to provide the seal between the first and second hubs. For example, the seal may engage the first annular recess 150 in the first hub 146 and the second annular recess in the second hub, and the seal may be compressed between the hubs via the coupling of the flanges. Furthermore, in the illustrated embodiment, each flange includes respective openings 152 (e.g., substantially evenly distributed along a circumferential axis of the flange). Fasteners may extend through the openings 152 in the first flange and the openings in the second flange to couple the flanges to one another.

In the illustrated embodiment, the first hub 146 has first interior threads 154 configured to engage the first exterior threads 46 at the first longitudinal end 48 of the first wellbore casing 50. In addition, the second hub has second interior threads configured to engage the second exterior threads of the second wellbore casing. Engagement of the first interior threads 154 of the first hub 146 with the first exterior threads 46 of the first wellbore casing 50 couples the first flange assembly 144 to the first wellbore casing 50, and engagement of the second interior threads of the second hub with the second exterior threads of the second wellbore casing couples the second flange assembly to the second wellbore casing. While each hub is coupled to the respective wellbore casing with a threaded connection in the embodiment disclosed herein, in other embodiments, at least one hub may be coupled to the respective wellbore casing by a welded connection, as discussed in detail below, or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types). In the embodiment disclosed herein, each hub is formed from a single piece of material (e.g., by a casting process, a forging process, a machining process, an additive manufacturing process, other suitable manufacturing process(es), or a combination thereof). However, in other embodiments, at least one hub may include multiple portions (e.g., as disclosed above) coupled to one another (e.g., a first portion configured to interface with the respective flange and a second portion having the respective interior threads).

In the illustrated embodiment, the first flange 148 is rotatably engaged with (e.g., coupled to) the first hub 146 and configured to rotate about a longitudinal axis 155 of the first flange assembly 144 relative to the first hub 146, thereby facilitating circumferential alignment of the openings of the first flange with the openings of the second flange. The first flange 148 is also configured to translate along the first hub 146 with respect to the longitudinal axis 155 of the first flange assembly 144. In addition, the first flange 148 has an annular recess 156, and the first hub 146 has an annular protrusion 158. Engagement of the annular recess 156 with the annular protrusion 158 blocks longitudinal movement of the first flange 148 relative to the first hub 146 along a direction toward the second flange. As a result, the seal between the hubs may be compressed via coupling the flanges to one another. In the illustrated embodiment, the first hub 146 includes a stop 160 configured to block longitudinal movement of the first flange 148 in a direction toward the first wellbore conduit 50. In the illustrated embodiment, the stop 160 is removable (e.g., the stop may be formed by a ring engaged with a slot in the first hub), thereby enabling formation of the first flange assembly 144. For example, the first flange 148 may be disposed about the first hub 146 before the stop 160 is attached. Furthermore, in certain embodiments, the stop may be omitted. While the first flange 148 has a recess 156 and the first hub 146 has a protrusion 158 in the illustrated embodiment, in other embodiments, the first flange assembly may include any other suitable structures configured to block longitudinal movement of the first flange relative to the first hub along a direction toward the second flange (e.g., a protrusion on the first flange configured to engage a recess within the first hub, pin(s) extending from the first hub configured to engage a longitudinal surface of the first flange, etc.).

In certain embodiments, the second flange is rotatably engaged with (e.g., coupled to) the second hub and configured to rotate about a longitudinal axis of the second flange assembly relative to the second hub, thereby facilitating circumferential alignment of the openings of the second flange with the openings of the first flange. The second flange is also configured to translate along the second hub with respect to the longitudinal axis of the second flange assembly. In addition, in certain embodiments, the second flange has an annular recess, and the second hub has an annular protrusion. Engagement of the annular recess with the annular protrusion blocks longitudinal movement of the second flange relative to the second hub along a direction toward the first flange. As a result, the seal between the hubs may be compressed via coupling the flanges to one another. In certain embodiments, the second hub includes a stop configured to block longitudinal movement of the second flange in a direction toward the second wellbore conduit. In certain embodiments, the stop is removable (e.g., the stop may be formed by a ring engaged with a slot in the second hub), thereby enabling formation of the second flange assembly. For example, the second flange may be disposed about the second hub before the stop is attached. Furthermore, in certain embodiments, the stop may be omitted. While the second flange has a recess and the second hub has a protrusion in the embodiment disclosed herein, in other embodiments, the second flange assembly may include any other suitable structures configured to block longitudinal movement of the second flange relative to the second hub along a direction toward the first flange (e.g., a protrusion on the second flange configured to engage a recess within the second hub, pin(s) extending from the second hub configured to engage a longitudinal surface of the second flange, etc.).

The first hub 146 also forms a portion of the second connection assembly 142. In the illustrated embodiment, the second connection assembly 142 includes the first hub 146, a second hub 162, and a clamp 164. As previously discussed, the first hub 146 has first interior threads 154 configured to engage the first exterior threads 46 at the first longitudinal end 48 of the first wellbore casing 50. In addition, the second hub 162 has second interior threads configured to engage the second exterior threads at the second longitudinal end of the second wellbore casing. Engagement of the first interior threads 154 of the first hub 146 with the first exterior threads 46 of the first wellbore casing 50 couples the first hub 146 to the first wellbore casing 50, and engagement of the second interior threads of the second hub 162 with the second exterior threads of the second wellbore casing couples the second hub 162 to the second wellbore casing. While each hub is coupled to the respective wellbore casing with a threaded connection in the embodiment disclosed herein, in other embodiments, at least one hub may be coupled to the respective wellbore casing by a welded connection or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types). In the embodiment disclosed herein, each hub is formed from a single piece of material (e.g., by a casting process, a forging process, a machining process, an additive manufacturing process, other suitable manufacturing process(es), or a combination thereof). However, in other embodiments, at least one hub may include multiple portions coupled to one another (e.g., a first portion configured to interface with the clamp and a second portion having the respective interior threads).

As previously discussed, the first hub 146 includes an annular protrusion 158. In addition, in the illustrated embodiment, the second hub 162 includes an annular protrusion 166. The clamp 164 includes an annular recess 168 configured to capture the annular protrusions, thereby coupling the first and second hubs to one another. In the illustrated embodiment, the clamp 164 includes two arcuate sections configured to couple to one another, thereby capturing the annular protrusions within the annular recess 168. In the illustrated embodiment, the clamp 164 includes openings 169. Fasteners may extend through the openings 169 to couple the two arcuate sections to one another. While the arcuate sections of the clamp are coupled to one another via fasteners in the illustrated embodiment, in other embodiments, the arcuate sections may be coupled to one another by other suitable fastening device(s) (e.g., alone or in combination with the fasteners), such as latch(es), strap(s), other suitable fastening device(s), or a combination thereof. Furthermore, while the clamp includes two arcuate sections in the illustrated embodiment, in other embodiments, the clamp may include more arcuate sections (e.g., 3, 4, or more). In addition, while a clamp having an annular recess is disclosed above, in certain embodiments, the clamp may have any other suitable structure configured to couple the hubs to one another. For example, in certain embodiments, the hubs may include annular recesses and the clamp may include corresponding annular protrusions configured to engage the annular recesses of the hubs.

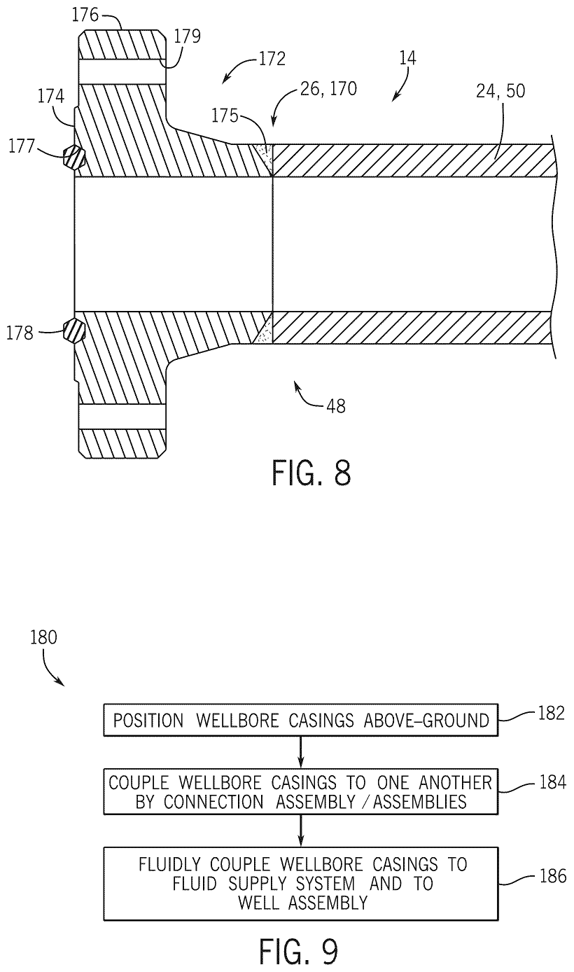

FIG. 8 is a cross-sectional view of a portion of a further embodiment of a connection assembly 170 that may be employed within the fluid transfer assembly 14 of FIG. 2. In the illustrated embodiment, the connection assembly 170 includes a first flange assembly 172 and a second flange assembly. As illustrated, the first flange assembly 172 is coupled to the first longitudinal end 48 of the first wellbore conduit 50. The first flange assembly 172 includes a first hub 174 and a first flange 176, and the second flange assembly includes a second hub and a second flange. The first and second flanges are configured to couple to one another to establish a seal between the first and second hubs. In the illustrated embodiment, the first flange assembly 172 is configured to couple to the second flange assembly, which is coupled to a second longitudinal end of a second wellbore casing. In addition, the first flange assembly 172 and/or the second flange assembly may also be configured to couple to the fluid supply system, to the well assembly (e.g., to the tree of the well assembly), to another suitable conduit, or a combination thereof.

In the illustrated embodiment, each hub includes an annular recess 177 configured to receive a seal 178 (e.g., API 6A ring gasket, metal seal, elastomeric seal, etc.), which is configured to provide the seal between the first and second hubs. For example, the seal may engage the first annular recess 177 in the first hub 174 and the second annular recess in the second hub, and the seal may be compressed between the hubs via the coupling of the flanges. Furthermore, in the illustrated embodiment, each flange includes respective openings 179 (e.g., substantially evenly distributed along a circumferential axis of the flange). Fasteners may extend through the openings 179 in the first flange and the openings in the second flange to couple the flanges to one another.

In the illustrated embodiment, the first flange assembly 172 is formed from a single piece of material, and the second flange assembly is formed from a single piece of material. Accordingly, each flange assembly does not include any welded connections, adhesive connections, or fasteners. For example, each flange assembly may be formed by a casting process, a forging process, a machining process, an additive manufacturing process, other suitable manufacturing process(es), or a combination thereof. While each flange assembly is formed from a single piece of material in the illustrated embodiment, in other embodiments, at least one flange assembly may be formed from multiple pieces of material coupled to one another. For example, in certain embodiments, the flange and the hub may be separate components coupled to one another to form the respective flange assembly, and/or at least one hub may include multiple portions (e.g., as disclosed above) coupled to one another (e.g., a first portion configured to interface with the respective flange and a second portion having the respective interior threads).

In the illustrated embodiment, the first hub 174 is coupled to the first end 48 of the first wellbore casing 50 by a welded connection 175. In addition, the second hub is coupled to the second end of the second wellbore casing by a welded connection. While each hub is coupled to the respective wellbore casing by a welded connection in the embodiment disclosed herein, in other embodiments, at least one hub may be coupled to the respective wellbore casing by a threaded connection, as discussed in detail above, or by another suitable type of connection (e.g., pinned connection, fastener connection, adhesive connection, etc.). Furthermore, in certain embodiments, at least one hub may be coupled to the respective wellbore casing by multiple connections (e.g., of the same type and/or of different types). In embodiments in which a hub is welded to the respective wellbore casing, the exterior threads of the respective wellbore casing may be omitted. For example, the wellbore casing may be formed without respective exterior threads, or the respective threaded portion of the wellbore casing may be removed (e.g., via a cutting process).

Each of the flange assemblies disclosed herein may be formed to comply with any applicable standards, such as American Petroleum Institute (API) 6A, API 61, etc. Furthermore, any of the flange assemblies disclosed herein may be used with any other flange assembly disclosed herein to form a connection assembly. For example, in certain embodiments, one of the flange assemblies disclosed above with reference to FIG. 3 may be coupled to the flange assembly disclosed above with reference to FIG. 7 to form a connection assembly. Furthermore, while connection assemblies including flange assemblies, clamps, and collars are disclosed herein, at least one connection assembly may include another suitable type of connection components.

FIG. 9 is a flow diagram of an embodiment of a method 180 for forming a fluid transfer assembly. In the illustrated embodiment, the method 180 includes positioning multiple wellbore casings above-ground. As previously discussed, at least one wellbore casing of the fluid transfer assembly may be positioned below-ground, and/or portion(s) of at least one wellbore casing of the fluid transfer assembly may be positioned below-ground. Next, as represented by block 184, the wellbore casings are coupled to one another by at least one connection assembly. As previously discussed, each connection assembly may include flange assemblies, a clamp, or a collar, among other suitable components. In addition, the wellbore casings are fluidly coupled to a fluid supply system (e.g., the well stimulation fluid supply system, etc.) and to a well assembly (e.g., the well assembly having the well stimulation tree, etc.), as represented by block 186. Accordingly, the wellbore casings are configured to receive fluid (e.g., high-pressure fracturing fluid, etc.) from the fluid supply system and to provide the fluid to the well assembly. As previously discussed, each wellbore casing is configured (e.g., designed) to be disposed within a wellbore to facilitate fluid flow through the wellbore. The method 180 may be performed in the order disclosed herein or in any other suitable order.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A fluid transfer assembly, comprising:
a first wellbore casing positioned above-ground, wherein the first wellbore casing is configured to receive fluid from a fluid supply system and to provide the fluid to a well assembly;
a second wellbore casing positioned above-ground, wherein the second wellbore casing is configured to receive the fluid from the fluid supply system and to provide the fluid to the well assembly; and
a connection assembly coupling the first wellbore casing and the second wellbore casing;
wherein the first wellbore casing and the second wellbore casing are configured to be disposed within a wellbore to facilitate fluid flow through the wellbore.

2. The fluid transfer assembly of claim 1, wherein a first maximum design pressure of the first wellbore casing is less than 20,000 psi, and a second maximum design pressure of the second wellbore casing is less than 20,000 psi.

3. The fluid transfer assembly of claim 1, wherein a first length of the first wellbore casing is at least 30 feet, and a second length of the second wellbore casing is at least 30 feet.

4. The fluid transfer assembly of claim 1, wherein the connection assembly comprises a collar, the collar has first interior threads at a first longitudinal end of the collar, the first interior threads are configured to engage first exterior threads at a first longitudinal end of the first wellbore casing, the collar has second interior threads at a second longitudinal end of the collar, and the second interior threads are configured to engage second exterior threads at a second longitudinal end of the second wellbore casing.

5. The fluid transfer assembly of claim 1, wherein the connection assembly comprises a first flange assembly and a second flange assembly, the first flange assembly comprises a first hub and a first flange, the second flange assembly comprises a second hub and a second flange, and the first and second flanges are configured to couple to one another to establish a seal between the first and second hubs.

6. The fluid transfer assembly of claim 5, wherein the first flange assembly is formed from a single piece of material, the second flange assembly is formed from a single piece of material, or a combination thereof.

7. The fluid transfer assembly of claim 5, wherein the first hub has first interior threads configured to engage first exterior threads at a first longitudinal end of the first wellbore casing, the second hub has second interior threads configured to engage second exterior threads at a second longitudinal end of the second wellbore casing, or a combination thereof.

8. The fluid transfer assembly of claim 5, wherein the first hub has first interior threads configured to engage first exterior threads at a first longitudinal end of the first wellbore casing, and the first hub comprises a first portion integrally formed with the first flange and a second portion having the first interior threads;
wherein the second hub has second interior threads configured to engage second exterior threads at a second longitudinal end of the second wellbore casing, and the second hub comprises a first portion integrally formed with the second flange and a second portion having the second interior threads; or
a combination thereof.

9. The fluid transfer assembly of claim 5, wherein the first hub has first interior threads configured to engage first exterior threads at a first longitudinal end of the first wellbore casing, the first hub comprises a first portion integrally formed with the first flange and a second portion having the first interior threads, and the first flange assembly comprises a first gusset extending between the first flange, the first portion of the first hub, or a combination thereof, and the second portion of the first hub;
wherein the second hub has second interior threads configured to engage second exterior threads at a second longitudinal end of the second wellbore casing, the second hub comprises a first portion integrally formed with the second flange and a second portion having the second interior threads, and the second flange assembly comprises a second gusset extending between the second flange, the first portion of the second hub, or a combination thereof, and the second portion of the second hub; or
a combination thereof.

10. The fluid transfer assembly of claim 5, wherein the first flange is configured to rotate about a longitudinal axis of the first flange assembly relative to the first hub, the second flange is configured to rotate about a longitudinal axis of the second flange assembly relative to the second hub, or a combination thereof.

11. The fluid transfer assembly of claim 5, wherein the first flange has first interior threads engaged with first exterior threads of the first hub, the second flange has second interior threads engaged with second exterior threads of the second hub, or a combination thereof.

12. The fluid transfer assembly of claim 5, wherein the first hub is welded to a first longitudinal end of the first wellbore casing, the second hub is welded to a second longitudinal end of the second wellbore casing, or a combination thereof.

13. The fluid transfer assembly of claim 1, wherein the connection assembly comprises a first hub, a second hub, and a clamp, the first hub has first interior threads configured to engage first exterior threads at a first longitudinal end of the first wellbore casing, the second hub has second interior threads configured to engage second exterior threads at a second longitudinal end of the second wellbore casing, and the clamp is configured to couple the first and second hubs to one another.

14. A method for forming a fluid transfer assembly, comprising:
positioning a plurality of wellbore casings above-ground;
coupling the plurality of wellbore casings to one another by at least one connection assembly; and
fluidly coupling the plurality of wellbore casings to a fluid supply system and to a well assembly to enable the plurality of wellbore casings to receive fluid from the fluid supply system and to provide the fluid to the well assembly;
wherein each wellbore casing of the plurality of wellbore casings is configured to be disposed within a wellbore to facilitate fluid flow through the wellbore.

15. The method of claim 14, wherein a maximum design pressure of each wellbore casing of the plurality of wellbore casings is less than 20,000 psi.

16. The method of claim 14, wherein a length of each wellbore casing of the plurality of wellbore casings is at least 30 feet.

17. A fluid transfer assembly, comprising:
a first wellbore casing positioned outside of a wellbore of a well, wherein the first wellbore casing is configured to receive fluid from a fluid supply system and to provide the fluid to a well assembly;
a second wellbore casing positioned outside of the wellbore, wherein the second wellbore casing is configured to receive the fluid from the fluid supply system and to provide the fluid to the well assembly; and
a connection assembly coupling the first wellbore casing and the second wellbore casing;
wherein the first wellbore casing and the second wellbore casing are configured to be used within the wellbore to facilitate fluid flow through the wellbore.

18. The system of claim 17, wherein a first maximum design pressure of the first wellbore casing is less than 20,000 psi, and a second maximum design pressure of the second wellbore casing is less than 20,000 psi.

19. The system of claim 17, wherein a first length of the first wellbore casing is at least 30 feet, and a second length of the second wellbore casing is at least 30 feet.

20. The system of claim 17, wherein the connection assembly comprises a first flange assembly and a second flange assembly, the first flange assembly comprises a first hub and a first flange, the second flange assembly comprises a second hub and a second flange, and the first and second flanges are configured to couple to one another to establish a seal between the first and second hubs.
